(19) United States
(12) Patent Application Publication
(10) Pub. No.: US 2012/0208054 A1
(43) Pub. Date: Aug. 16, 2012

(54) BATTERY SYSTEM AND BATTERY STRUCTURE

(75) Inventors: Atsushi SHIRASAWA, Sunto-gun (JP); Hiroshi TERANISHI, Sunto-gun (JP); Hirotoshi IMAI, Mishima-shi (JP)

(73) Assignee: TOYOTA JIDOSHA KABUSHIKI KAISHA, Toyota-shi (JP)

(21) Appl. No.: 13/372,980

(22) Filed: Feb. 14, 2012

(30) Foreign Application Priority Data
Feb. 16, 2011 (JP) 2011-030759
Mar. 16, 2011 (JP) 2011-057839

(51) Int. Cl. H01M 10/48

(52) U.S. Cl. 429/90

(57) ABSTRACT

A battery system is provided with: an assembled battery having a plurality of solid-state unit cells; an assembled battery case that houses the assembled battery; a gas that fills an interior of the assembled battery case; a pressing section that pressurizes the unit cells with hydrostatic pressure that is generated in the assembled battery case by the gas; a deformation section that is part of the assembled battery case and that, upon occurrence of an anomaly in the assembled battery case, deforms in reaction to the anomaly; and a sensing section that senses deformation of the deformation section.

### INCORPORATION BY REFERENCE

The disclosure of Japanese Patent Application No. 2011-030759 filed on Feb. 16, 2011, Japanese Patent Application No. 2011-057839 filed on Mar. 16, 2011 including the specification, drawings and abstract is incorporated herein by reference in its entirety.

### BACKGROUND OF THE INVENTION

1. Field of the Invention

The invention relates to a battery system in which a battery cell is pressurized, and to a structure thereof.

2. Description of Related Art

The demand for secondary batteries as power sources has grown in recent years, in equipment ranging from small devices such as mobile phones up to large machinery items such as automobiles. This has been accompanied by a drive towards greater performance in such secondary batteries, in particular greater capacity.

Secondary batteries that are used for the above applications are provided with, at least, a positive electrode, a negative electrode and an electrolyte interposed between the positive electrode and the negative electrode. Among the foregoing, the electrolyte used is a medium, in the form of a liquid electrolyte or a solid electrolyte, that mediates ion conduction between the positive electrode and the negative electrode.

In a case where a liquid electrolyte (hereafter also referred to as “electrolyte solution”) is used as the electrolyte of the secondary battery, the interior of a positive electrode layer and a negative electrode layer becomes readily impregnated with the electrolyte solution. As a result, an interface forms readily between the electrolyte solution and the active material that is contained in the positive electrode layer and the negative electrode layer, and performance is readily enhanced. However, widely used electrolyte solutions are ordinarily flammable, and hence measures for securing safety must be taken. Measures must also be taken to prevent situations in which the electrolyte solution leaks out of a chassis (liquid leaks).

Such liquid leaks do not occur in batteries that employ electrolytes that are solid (hereafter also referred to as “solid electrolytes”). Also, solid electrolytes are ordinarily non-flammable. Accordingly, the above measures can be simplified or omitted. Accordingly, secondary batteries (hereafter also referred to as “solid batteries”) have been proposed that are provided with a layer that contains a non-flammable solid electrolyte (hereafter also referred to as “solid electrolyte layer”). In order to reduce internal resistance, technologies have been proposed that rely on causing a positive electrode layer, a solid electrolyte layer and a negative electrode layer to be more strongly adhered to each other, through application of pressure in the direction in which the various layers are stacked, so that interfacial resistance is reduced as a result.

Instances of technologies relating to such batteries include, for instance, the lithium ion secondary battery disclosed in Japanese Patent Application Publication No. 10-214638 (JP-A-10-214638), wherein unit cells (battery cells), each of which is made up of a negative electrode and a positive electrode capable of storing and releasing lithium, a nonaqucous electrolyte solution, and a case that houses the foregoing, are combined as a plurality thereof and accommodated in an assembled battery case (chassis), to yield an assembled battery, such that the unit cells are pressurized by hydrostatic pressure that is generated inside the assembled battery case through filling of at least one material type from among a gas, a liquid or a solid powder, or a mixed material of the foregoing, into a space inside the assembled battery case. In the battery disclosed in JP-A-10-214638, the unit cells are pressurized by hydrostatic pressure that is generated in a case, and hence a situation can be prevented in which the pressure exerted on the unit cells exhibits variability. Accordingly, a situation is averted wherein some of the unit cells degrade (local degradation) faster than other unit cells, and hence loss of performance of the assembled battery as a whole, in particular impairment of cycle characteristics, can be reduced.

In a battery where the unit cells are pressurized by such hydrostatic pressure, the internal resistance in the unit cells may vary depending on the value of the pressure that is exerted on the unit cells. Preferably, therefore, the hydrostatic pressure inside the assembled battery case is set to be equal to or greater than a given value, in order to enhance battery performance. From the viewpoint of increasing, for instance, battery safety, the hydrostatic pressure is also preferably set so as to be equal to or smaller than a given value. Therefore, the hydrostatic pressure in the assembled battery case must be managed so as to lie within a predetermined range. In the battery disclosed in JP-A-10-214638, management of the hydrostatic pressure in the assembled battery case is accomplished by separately manufacturing a sealed chassis to which a strain gauge is affixed, arranging the sealed chassis in the assembled battery case, and measuring the strain of the sealed chassis. Such a method for managing hydrostatic pressure, however, relies on a complex system, which drives up costs. Japanese Patent Application Publication No. 2006-128122 (JP-A-2006-128122) discloses a battery module wherein one structure is formed through mutual joining of partition walls by side-face plates of a case, as a result of which irregular changes of the entire case upon action of an external force can be prevented, and there can be enhanced the safety of the unit batteries that are inserted in the case. Japanese Patent Application Publication No. 2007-66612 (JP-A-2007-66612) discloses a battery structure in which battery elements are packaged, together with an electrolyte, by means of a laminate outer package, wherein the laminate has a multilayer structure, and a sensor is built thereinto that senses elongation between layers. However, the above problems were difficult to solve, even through a combination of the features disclosed in documents JP-A-2006-128122 and JP-A-2007-66612.

Lithium ion batteries are widely used as power sources for portable devices such as mobile phones, digital cameras and the like. In the automotive industry as well, high-output, high-capacity lithium ion batteries are being developed for installation in, for instance, electric vehicles (EVs) and hybrid vehicles (HEVs).

Available such lithium ion batteries include, for instance, batteries of laminate cell type in which an electrode plate group is packaged in a laminate film and is sealed in the form of a flat plate. It has been proposed to use, in EV and HEV applications, among others, assembled batteries in which such lithium ion batteries of laminate cell type are arrayed as a plurality thereof in the thickness direction, and are housed within a case.

In JP-A-10-214638, identical pressure is exerted on all unit cells in the assembled battery of such a lithium secondary battery through filling of a hydrostatic pressure-eliciting medium, such as a gas or the like, into a space within the assembled battery case. It is reported that, as a result, not only does the internal resistance value of the unit cells drop, but also fluctuations in internal resistance value between unit cells becomes smaller as well, so that a lithium secondary battery can be obtained that has excellent cycle characteristics given the high capacity of the battery.

In the lithium secondary battery disclosed in JP-A-10-214638, the high-pressure hydrostatic pressure-eliciting medium that is filled into the assembled battery case may leak out, for instance, if the assembled battery case is damaged, and the battery characteristic of the lithium secondary battery may be impaired as a result. In a case where, in particular, the hydrostatic pressure-eliciting medium is a gas, it is not possible to determine easily, for instance, whether such a drop in battery characteristic is caused by a gas leak, or which portion in the assembled battery case is the site at which the gas leak has occurred. As a result, the lithium secondary battery disclosed in JP-A-10-214638 does not allow taking quick and appropriate measures for restoring pressure inside the assembled battery case.

### SUMMARY OF THE INVENTION

The invention provides a battery system and a battery structure that allows sensing, in a simple manner, anomalies that occur in a battery case.

A battery system according to a first aspect of the invention is provided with: an assembled battery having a plurality of solid-state unit cells; an assembled battery case that houses the assembled battery; a gas that fills an interior of the assembled battery case; a pressing section that pressurizes the unit cells with hydrostatic pressure that is generated in the assembled battery case by the gas; a deformation section that is part of the assembled battery case and that, upon occurrence of an anomaly in the assembled battery case, deforms in reaction to the anomaly; and a sensing section that senses deformation of the deformation section.

In the battery system according to the first aspect, “unit cell” denotes conceptually a unit cell that has a pair of electrode layers and an electrolyte layer disposed between the electrode layers of the pair thereof, but does not conceptually encompass an aggregate resulting from connecting and/or stacking a plurality of unit cells. The “pair of electrode layers” denotes a pair of a positive electrode layer and a negative electrode layer. The feature “disposed between” indicates that the electrolyte layer is present between the positive electrode layer and the negative electrode layer, such that other layers having ion conductivity may be interposed between the electrolyte layer and the positive electrode layer and/or the negative electrode layer. A “solid-state unit cell” denotes a unit cell wherein all the layers that make up the unit cell are solid. That is, an electrolyte layer in a solid-state unit cell is a solid electrolyte layer. The “assembled battery” denotes a battery that operates as one battery through connection of a plurality of unit cells in series or in parallel. The “hydrostatic pressure” denotes the pressure that a gas exerts, from all directions, onto any one point that is present in the gas. The “anomaly” in the assembled battery case encompasses conceptually at least one situation where the pressure inside the assembled battery case deviates from a predetermined range.

A battery structure according to a second aspect of the invention is provided with: at least one laminate cell; and an outer package that houses the at least one laminate cell; such that the at least one laminate cell is pressurized and held through filling of a gas into a space in the outer package; and at least part of an outer surface of the outer package is covered by a material for detecting a leak of the gas from the outer package.

The battery structure according to the second aspect allows easily determining the portion at which a gas leak from the outer package, if any such gas leak occurs. Accordingly, it becomes possible to take quick and appropriate measures for restoring pressure inside the assembled battery case.

By virtue of the above aspects of the invention, a battery system and a battery structure may be provided that allow sensing, in a simple manner, anomalies that occur in a battery case.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a cross-sectional diagram for explaining schematically a battery system according to a first embodiment of the invention;

FIG. 2 is a cross-sectional diagram for explaining schematically a solid-state unit cell according to the first embodiment;

FIG. 3 is a cross-sectional diagram for explaining schematically a battery system according to a second embodiment of the invention;

FIG. 4 is a cross-sectional diagram for explaining schematically a battery system according to a third embodiment of the invention;

FIG. 5 is a diagram illustrating schematically a laminate cell that is ordinarily used in a battery structure of a battery system according to a fourth embodiment of the invention; and

FIG. 6 is a diagram illustrating schematically an example of a battery structure according to a fourth embodiment of the invention.

### DETAILED DESCRIPTION OF EMBODIMENTS

The invention will be explained next based mainly on examples of a configuration having a lithium ion secondary battery and wherein one assembled battery case is provided inside one chassis. The below-described configurations are illustrative of the invention, but the invention is not limited to these configurations in any way. Some of the reference numerals may be omitted in the drawings. In the disclosure below, unless otherwise stated, “X to Y” denotes “equal to or greater than X and equal to or smaller than Y”.

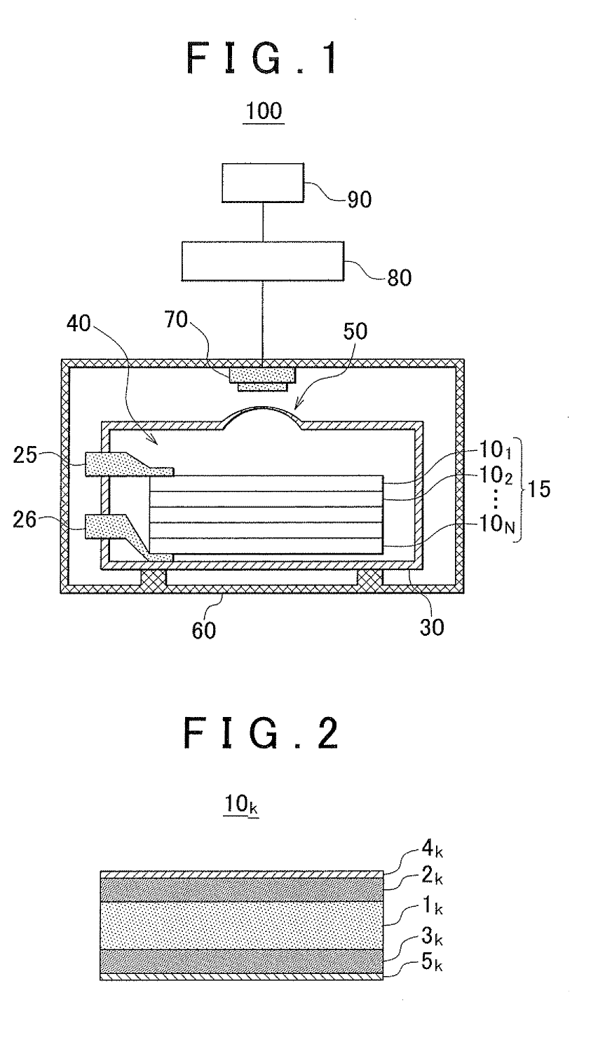

FIG. 1 is a cross-sectional diagram for explaining schematically a battery system 100 according to a first embodiment of the invention. As illustrated in FIG. 1, the battery system 100 is provided with an assembled battery 15; an assembled battery case 30 that houses the assembled battery 15; a gas 40 that fills the interior of the assembled battery case 30; a deformation section 50 provided in the assembled battery case 30; a chassis 60 that houses the assembled battery case 30; a contact actuation sensor 70 (sensing section) disposed in the chassis 60; a control unit 80 connected to the contact actuation sensor 70; and a notification unit 90 connected to the control unit 80. The contact actuation sensor 70 is disposed on an inner face of the chassis 60, close to the deformation section 50. The assembled battery 15 has N solid-state unit cells 10₁, . . . , 10_{N} and is connected to a positive electrode terminal 25 and a negative electrode terminal 26. The positive electrode terminal 25 and the negative electrode terminal 26 are fixed to the assembled battery case 30, such that at least part of the positive electrode terminal 25 and the negative electrode terminal 26 is exposed outside the assembled battery case 30.

Herein, a feature wherein a sensor is of “contact actuation” indicates that the sensor has a portion (contact) for contact with an object to be sensed, such that the contact is displaced through coming into contact with the object to be sensed, or by contact with the object to be sensed and by being acted upon by an external force, whereupon the sensor outputs a signal in reaction to the displacement of the contact.

The assembled battery 15 is a stacked assembled battery in which the N solid-state unit cells 10₁, . . . , 10_{N} are connected to each other by stacking. FIG. 2 is a cross-sectional diagram for explaining schematically one solid-state unit cell 10ₖ (k=1, . . . N). As illustrated in FIG. 2, the solid-state unit cell 10ₖ has a solid electrolyte layer 1ₖ; a positive electrode layer 2ₖ and a negative electrode layer 3ₖ that are disposed so as to sandwich the solid electrolyte layer 1ₖ; a positive electrode collector 4ₖ disposed on the surface of the positive electrode layer 2ₖ; and a negative electrode collector 5ₖ disposed on the surface of the negative electrode layer 3ₖ. In the assembled battery 15, the N solid-state unit cells 10₁, . . . , 10_{N} are connected in series by being stacked in the order 10₁, . . . , 10_{N}, from the top of the paper in FIG. 2 downwards in the up-and-down direction of the paper in FIG. 2. In the battery system 100, the positive electrode collector 4₁ of the solid-state unit cell 10₁ on an outermost side of the assembled battery 15 is connected to the positive electrode terminal 25, and the negative electrode collector 5_{N} of the solid-state unit cell 10_{N} on an outermost side of the assembled battery 15 is connected to the negative electrode terminal 26. The subscripts k (k=1, . . . N) will be omitted hereafter.

The solid electrolyte layer 1 that is used can be produced, for instance, through press-molding of a solid electrolyte. Also, there can be used a solid electrolyte layer produced by coating a slurry of a mixture of a solid electrolyte and a solvent, followed by drying. The solid electrolyte layer 1 that is used can be produced independently, or can have formed, on the surface thereof, a below-described positive electrode layer 2 or negative electrode layer 3. As the solid electrolyte contained in the solid electrolyte layer 1 there can be used a commonly available solid electrolyte having lithium ion conductivity, without any particular limitations. For instance, there can be used a sulfide solid electrolyte such as Li₂S—P₂S₅, or an oxide solid electrolyte such as Li₃PO₄.

The positive electrode layer 2 need only contain a positive electrode active material, but may contain a solid electrolyte in addition to the positive electrode active material. As the positive electrode active material in the positive electrode layer 2 there can be used, for instance, lithium cobaltate. As the solid electrolyte there can be used a commonly available solid electrolyte having lithium ion conductivity (for instance, a sulfide solid electrolyte such as Li₂S—P₂S₅, or an oxide solid electrolyte such as Li₃PO₄). In addition, the positive electrode layer 2 may also contain a commonly available conduction aid (for instance, acetylene black) that readily forms electron conduction paths, as well as a commonly available binder (for instance, polyvinylidene fluoride) that binds all these materials. The positive electrode layer 2 can be produced according to an available method. The form of the positive electrode layer 2 is not particularly limited, so long as the positive electrode layer 2 can be appropriately formed on the surface of the below-described positive electrode collector 4. The thickness of the positive electrode layer 2 can be set to range from, for instance, about 5 μm to 500 μm.

The negative electrode layer 3 need only contain a negative electrode active material, but may contain a solid electrolyte in addition to the negative electrode active material. As the negative electrode active material contained in the negative electrode layer 3 there can be used, for instance, graphite carbon. As the solid electrolyte there can be used a commonly available solid electrolyte having lithium ion conductivity (for instance, a sulfide solid electrolyte such as Li₂S—P₂S₅, or an oxide solid electrolyte such as Li₃PO₄). In addition, the negative electrode layer 3 may also contain a commonly available conduction aid (for instance, acetylene black) that readily forms electron conduction paths, as well as a commonly available binder (for instance, polyvinylidene fluoride) that binds all these materials. The negative electrode layer 3 can be produced according to an available method. The form of the negative electrode layer 3 is not particularly limited, so long as negative electrode layer 3 can be appropriately formed on the surface of the below-described negative electrode collector 5. The thickness of the negative electrode layer 3 can be set to range from, for instance, about 5 μm to 500 μm.

The materials and so forth of the positive electrode collector 4 and the negative electrode collector 5 are not particularly limited so long as they are collectors that can be used as a positive electrode collector and a negative electrode collector in a battery having solid-like electrolyte layers. For example, metal foils, metal meshes, metal vapor-deposited films or the like may be used as the collectors. For instance, there can be used a metal foil or mesh made up of a metallic material that includes one or more elements selected from the group consisting of Cu, Ni, Al, V, Au, Pt, Mg, Fe, Ti, Co, Cr, Zn, Ge and In; or a film of polyimide, polyimide, polyethylene terephthalate (PET), polyphenylene sulfide (PPS), polypropylene or the like, or a glass, silicon plate or the like, having the abovementioned metallic materials vapor-deposited thereon. The form of the positive electrode collector 4 and the negative electrode collector 5 is not particularly limited, and the thickness thereof can range, for instance, from about 5 μm to 500 μm.

The positive electrode terminal 25 and the negative electrode terminal 26 that are used are not particularly limited, and may be metal sheets, metal rods or the like, so long as they are terminals that can be used as terminals for lithium ion secondary batteries. For instance, there can be used commonly available materials having good conductivity, such as Cu, Au or the like.

The assembled battery case 30 is a member that houses the assembled battery 15 and that holds the below-described gas 40 in such a manner that the latter does not leak out. From the viewpoint of withstanding the pressure of the gas 40 and facilitating weight reduction of the battery system 100 as a whole, a metallic material such as aluminum or the like can be preferably used as the material that makes up the assembled battery case 30. The assembled battery case 30 is provided with the below-described deformation section 50.

The gas 40 is a gas that fills the interior of the assembled battery case 30 in order to pressurize the assembled battery 15 through hydrostatic pressure. Examples of the gas 40 include gases that are inert towards the constituent material of the assembled battery 15. Examples of such a gas 40 include, for instance, argon or the like.

The gas 40 that is used may be a mixture of a plurality of gas components. Preferably, the pressure of the gas 40 is set to, for instance, 0.1 kgf/cm² to 40 kgf/cm² at 20° C. Setting the pressure of the gas 40 at 20° C. to be equal to or greater than 0.1 kgf/cm² allows enhancing the degree of adhesion between the various layers that make up the assembled battery 15, and hence the internal resistance of the assembled battery 15 can be reduced in an easy manner. Setting the pressure of the gas 40 at 20° C. to be equal to or smaller than 40 kgf/cm² makes it easy to suppress increases in internal resistance of the assembled battery 15 derived from a drop in the hydrostatic pressure that is exerted on the assembled battery 15, as a result of leaks of gas 40 out of the assembled battery case 30 upon crushing of the latter.

The deformation section 50 is a portion, provided on an outer plate of the assembled battery case 30, having partially reduced rigidity. That is, the deformation section 50 is a portion of the assembled battery case 30 having lower rigidity than other portions of the assembled battery case 30. In the battery system 100, the deformation section 50 as a protrusion can be formed, for instance, by pushing up a part, by pressing, of the outer plate that is to make up the assembled battery case 30, such that the pushed portion bulges upwards, prior to assembly of the assembled battery case 30. The plate thickness of the protrusion is made smaller than the surrounding plate thickness through stretching of the plate during pressing. As a result, the deformation section 50 has a lower rigidity than that of the surroundings.

As described above, the deformation section 50 has lower rigidity than the surroundings at the outer plate of the assembled battery case 30. As a result, the deformation section 50 deforms so as to bulge outwards from the assembled battery case 30, ahead of other portions of the assembled battery case 30, when, for instance, the pressure inside the assembled battery case 30 (hereafter also referred to as “internal pressure”) rises abnormally, and the difference with the pressure outside the assembled battery case 30 (hereafter also referred to as “external pressure”) exceeds a predetermined threshold value. Herein, the difference between the external pressure and the internal pressure of the assembled battery case 30 (internal pressure-external pressure, hereafter also referred to as “internal-external pressure difference”) that constitutes the threshold value of the time at which deformation of the deformation section 50 starts is preferably set to be 10% or more of the external pressure. Preferably, thus, the deformation section 50 operates when the internal pressure rises to be 10% or more higher than the external pressure. The action of the deformation section 50, triggered when the internal pressure exceeds the external pressure by 10% or more, allows easing malfunctions upon fluctuations in the internal-external pressure difference that derive from external factors, such as temperature or the like.

The chassis 60 is a member that houses the assembled battery case 30 and holds the latter at an appropriate position, and that holds the below-described contact actuation sensor 70 at an appropriate position. The material that makes up the chassis 60 is not particularly limited, but the material used is preferably a material having good thermal conductivity, in terms of efficiently dissipating the heat that is generated accompanying charge and discharge of the assembled battery 15. Examples of such a material include, for instance, aluminum or the like.

The contact actuation sensor 70 is a sensing section, disposed inside the chassis 60, that senses deformation of the deformation section 50. Small deformation by the deformation section 50 can be sensed in an easy manner by arranging thus the contact actuation sensor 70 (sensing section) at a site other than the surface of the assembled battery case 30. The contact actuation sensor 70 is connected to the below-described control unit 80, such that the output of the contact actuation sensor 70 is transmitted to the control unit 80. In a case where a power source is necessary to operate the contact actuation sensor 70, power is supplied to the contact actuation sensor 70 by way of a power source wire, not shown, through the positive electrode terminal 25 and the negative electrode terminal 26 to which the assembled battery 15 is connected. The contact actuation sensor 70 is disposed close to the deformation section 50. That is, the contact actuation sensor 70 is disposed at a position that comes into contact with a portion of the deformation section 50 upon deformation of the deformation section 50 that is provided in the above-described assembled battery case 30. Preferably, a predetermined gap in normal times is provided between the contact actuation sensor 70 and the deformation section 50. Preferably, the gap ranges from, for instance, 1 mm to 10 mm. Setting the gap to be 1 mm or greater allows easily suppressing detection, as an anomaly, of natural expansion of the assembled battery case 30 as a result of temperature changes, not as a result of an anomaly. Setting the gap to be no greater than 10 mm enables fast sensing of deformation of the deformation section 50 in an easy manner, and hence allows sensing quickly abnormal rises in the internal pressure of the assembled battery case 30.

The control unit 80 controls the contact actuation sensor 70 and the below-described notification unit 90. To that end, the control unit 80 is connected to both the contact actuation sensor 70 and the notification unit 90. Specifically, the control unit 80 receives, and processes, an output signal from the contact actuation sensor 70, and, when the output signal indicates detection of deformation of the deformation section 50, this indication is outputted to the below-described notification unit 90. In a case where a power source is required for the operation of the control unit 80, power is supplied to the control unit 80 by way of a power source wire, not shown, through the positive electrode terminal 25 and the negative electrode terminal 26 to which the assembled battery 15 is connected. An available control device such as a microcontroller or the like may be used, without any particular limitations, as the control unit 80.

The notification unit 90 is connected to the control unit 80, and, in accordance with the output of the control unit 80, informs a user that an anomaly in the assembled battery case 30 has been detected. In a case where a power source is required for the operation of the notification unit 90, power is supplied to the notification unit 90 by way of a power source wire, not shown, through the positive electrode terminal 25 and the negative electrode terminal 26 to which the assembled battery 15 is connected. As the notification unit 90 there can be used a light-emitting element such as a light bulb, a light-emitting diode (LED), an organic electroluminescent (organic EL) or the like; a text display element such as a liquid crystal module or a liquid crystal panel; an acoustic element such as a piezoelectric buzzer; or a transducer or the like; singly or as a combination of a plurality thereof.

In the battery system 100, an anomalous rise in the pressure inside the assembled battery case 30 is detected through sensing, by the contact actuation sensor 70, of deformation in the deformation section 50, and the user is informed by the notification unit 90. Conceivable situations that may result in abnormal rises in pressure inside the assembled battery case 30 include, for instance, overheating arising from use under harsh high-temperature environments; rises in the pressure of the gas 40 itself, as a result of anomalous heat generation caused by excessive current flow on account of a failure such as a short-circuit or the like; and also rises in the internal pressure of the airtight assembled battery case 30 through generation of gas as a result of anomalous reactions inside the assembled battery 15. An explanation follows next on the operation of the battery system 100 in a case of anomalous rise of the pressure inside the assembled battery case 30.

When the pressure inside the assembled battery case 30 rises for some reason and the internal-external pressure difference exceeds the above-mentioned predetermined threshold value, the deformation section 50 provided in the assembled battery case 30 deforms, so as to bulge outwards, ahead of other portions of the assembled battery case 30. Upon deformation of the deformation section 50, the latter comes into contact with the contact actuation sensor 70 that is provided in the chassis 60, close to the deformation section 50 before deformation. When the contact actuation sensor 70 senses contact, the output signal of the contact actuation sensor 70 changes, and this change is detected by the control unit 80 that is connected to the contact actuation sensor 70. Upon detection of the change in the signal inputted from the contact actuation sensor 70, the control unit 80 outputs a signal to the notification unit 90 that is connected to the control unit 80. In accordance with the output from the control unit 80, the notification unit 90 notifies the user that pressure inside the assembled battery case 30 has risen abnormally. In the battery system 100, there is sensed the deformation of the deformation section 50 provided in the assembled battery case 30, instead of performing direct monitoring of the pressure inside the assembled battery case 30. Therefore, pressure anomalies inside the assembled battery case 30 can be sensed in a simple manner.

In the above explanation relating to the invention, the battery system 100 has been illustrated in a configuration wherein the assembled battery 15 of the battery system 100 has solid-state unit cells 10₁, . . . , 10_{N} that are lithium ion secondary batteries, but the invention is not limited to the above configuration. Each unit cell that makes up the assembled battery can be a unit cell other than a solid-state unit cell being a lithium ion secondary battery. For instance, a battery system may be configured so as to an have assembled battery that is made up of a plurality of unit cells being each a so-called gel electrolyte lithium secondary battery in which not only an electrolyte but also a solvent is held in a polymeric body.

In the explanation relating to the invention, the battery system 100 has been illustrated in a configuration wherein the battery system 100 has the assembled battery 15 in which solid-state unit cells 10₁, . . . , 10_{N} are connected in series, but the invention is not limited to the above configuration. A form is also possible in which the assembled battery is configured through parallel connection of solid-state unit cells. Alternatively, a configuration is also possible in which the assembled battery is constructed as a combination of series connection and parallel connection.

In the explanation relating to the invention, the battery system 100 has been illustrated in a configuration wherein the deformation section 50 is configured through partial lowering of rigidity, by shaping part of the outer plate that is to make up the assembled battery case 30 into a convex form, by pressing, but the invention is not limited to the above configuration. The deformation section in the battery system of the invention can be configured by causing rigidity to be lower than at the surroundings in accordance with a method other than the above-described pressing, for instance mutual joining, by welding or the like, of dissimilar materials. A configuration is also possible in which the rigidity of one face of the assembled battery case is lowered by making the plate thickness of the one face smaller than that of other faces. In that case, such one face constitutes the deformation section. That is, the entire one face deforms so as to bulge outwards from the assembled battery case as a result of an anomalous rise in the internal pressure of the assembled battery case. Another configuration is also possible in which the rigidity of the assembled battery case is not lowered partially; instead, all the faces that make up the assembled battery case have the same plate thickness, such that the entire assembled battery case constitutes a deformation section. That is, the entire assembled battery case deforms so as to bulge outwards as a result of an anomalous rise in the internal pressure of the assembled battery case.

In the explanation relating to the invention, the battery system 100 has been illustrated in a configuration wherein the latter has the contact actuation sensor 70 as a sensing section, but the invention is not limited to the above configuration. The battery system of the invention can be configured so that the sensing section has a sensor other than a contact actuation sensor. Examples of sensors, other than contact actuation sensors, that can make up the sensing section include, for instance, contact-less sensors such as beam sensors or the like.

In the explanation relating to the invention, the battery system 100 has been illustrated in a configuration wherein the contact actuation sensor 70 (sensing section) is disposed on an inner face of the chassis 60, but the invention is not limited to the above configuration. In an electronic system of the invention, the sensing section need only be disposed so as to be capable of sensing the deformation of the deformation section. Therefore, a configuration is possible wherein the sensor is held, by way of a positioning section such a spacer or the like that is disposed on an inner face of the chassis, in accordance with a desired positional relationship between the sensor and the deformation section.

In the explanation relating to the invention, the battery system 100 has been illustrated in a configuration wherein a signal is outputted by the contact actuation sensor 70 (sensing section) to the notification unit 90, via the control unit 80, but the invention is not limited to the above configuration. Depending on the form of the notification unit and of the sensor that makes up the sensing section, a configuration is also possible in which the notification unit operates upon direct signal transmission from the sensing section to the notification unit, without the intervening control unit. In a case where, for instance, the sensing section is made up of a switch sensor of a form such that a conduction state is elicited by contact, and the notification unit is made up of an LED that emits light when energized, then the LED (notification unit) can be caused to emit light when the sensor (sensing section) detects contact, also with the sensor (sensing section) and the LED (notification unit) being directly connected to each other without the intervening control unit.

In the explanation relating to the invention, the battery system 100 has been illustrated in a configuration wherein the power source necessary for the contact actuation sensor 70 (sensing section), the control unit 80 and the notification unit 90 is supplied from the assembled battery 15. The number of parts can be reduced in an easy manner in such a configuration of the battery system 100. However, the invention is not limited to these configurations in any way. A form is also possible in which the power source necessary for the sensing section, the control unit and the notification unit is supplied by a power source supply section other than the assembled battery in the battery system of the invention. Examples of such a power source supply section include, for instance, an air battery, a liquid battery, a solar cell or the like. Such a configuration allows sensing, for instance, anomalies in the internal pressure of the assembled battery case, in a manner unaffected by the state of charge of the assembled battery in the battery system.

In the explanation relating to the invention, the battery system 100 has been illustrated in a configuration wherein one assembled battery case 30 is provided inside one chassis 60, but the invention is not limited to the above configuration. A form is also possible in which a plurality of assembled battery cases is provided in one chassis. In an instance where a plurality of assembled battery cases is provided in one chassis, then each assembled battery case may have a deformation section, and there may be provided a plurality of sensing sections, in one chassis, that correspond to respective sensing sections.

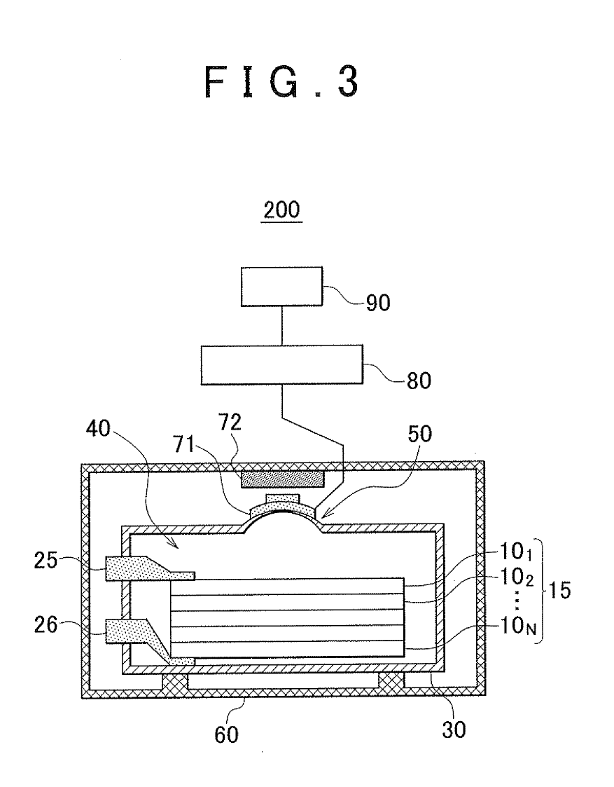

FIG. 3 is a cross-sectional diagram for explaining schematically a battery system 200 according to a second embodiment of the invention. As illustrated in FIG. 3, the battery system 200 is provided with an assembled battery 15; an assembled battery case 30 that houses the assembled battery 15; a gas 40 that fills the interior of the assembled battery case 30; a deformation section 50 provided in the assembled battery case 30; a contact actuation sensor 71 disposed close to the deformation section 50; a chassis 60 that houses the assembled battery case 30; a contact actuation sensor operating section 72 provided in the chassis 60; a control unit 80 connected to the contact actuation sensor 71; and a notification unit 90 connected to the control unit 80. The contact actuation sensor operating section 72 is disposed on an inner face of the chassis 60, close to the contact actuation sensor 71. A positive electrode terminal 25 and a negative electrode terminal 26 are connected to the assembled battery 15. The positive electrode terminal 25 and the negative electrode terminal 26 are fixed to the assembled battery case 30, such that at least part of the positive electrode terminal 25 and the negative electrode terminal 26 is exposed outside the assembled battery case 30.

The battery system 200 has a configuration identical to that of the battery system 100 according to the above-described first embodiment, except that herein the position at which the contact actuation sensor 71 is disposed is not on the chassis 60 side but on the deformation section 50 side (assembled battery case 30 side), and the contact actuation sensor operating section 72, which is a member for operating the contact actuation sensor 71, is disposed on the chassis 60 side. In the battery system 200, the sensing section is made up of the contact actuation sensor 71 and the contact actuation sensor operating section 72. Features of the battery system 200 that are dissimilar to those of the above-described battery system 100 will be explained next with reference to FIG. 3.

The contact actuation sensor 71 is a contact actuation sensor having a configuration identical to that of the above-described contact actuation sensor 70. As illustrated in FIG. 3, the contact actuation sensor 71 is disposed on the outward-side surface of the assembled battery case 30 that has the deformation section 50, in such a manner that the contact of the contact actuation sensor 71 faces outwards. The contact actuation sensor 71 is connected to the control device 80 in such a manner that an output signal of the contact actuation sensor 71 can be transmitted to the control device 80. In a case where a power source is necessary to operate the contact actuation sensor 71, power is supplied to the contact actuation sensor 71 by way of a power source wire, not shown, through the positive electrode terminal 25 and the negative electrode terminal 26 to which the assembled battery 15 is connected.

The contact actuation sensor operating section 72 is a member for coming into contact with the contact actuation sensor 71 and operating the contact actuation sensor 71 upon deformation of the deformation section 50. The contact actuation sensor operating section 72 need only reliably operate the contact actuation sensor 71 when coming into contact with the contact of the contact actuation sensor 71. For instance, a metallic or resin-made rod-like member may be used as the contact actuation sensor operating section 72. The contact actuation sensor operating section 72 is disposed on an inner face of the chassis 60, at a position close to the contact actuation sensor 71. The contact actuation sensor operating section 72 is provided, on an inner face of the chassis 60, at a position such that the contact actuation sensor operating section 72 comes into contact with the contact actuation sensor 71 as a result of displacement of the latter in response to deformation of the deformation section 50. Preferably, a predetermined gap in normal times is provided between the contact actuation sensor 71 and the contact actuation sensor operating section 72. A preferred extent of such a gap is identical to that of the preferred extent of the gap that is provided between the contact actuation sensor 70 and the deformation section 50 in the above-described battery system 100.

An explanation follows next on the operation of the battery system 200 in a case of anomalous rise of the pressure inside the assembled battery case 30.

When the pressure inside the assembled battery case 30 rises for some reason and the internal-external pressure difference exceeds the above-mentioned predetermined threshold value, the deformation section 50 provided in the assembled battery case 30 deforms, so as to bulge outwards, ahead of other portions of the assembled battery case 30. When the deformation section 50 deforms, the contact actuation sensor 71 disposed on the deformation section 50 becomes displaced in response to that deformation. Displacement of the contact actuation sensor 71 results in contact between the contact actuation sensor 71 and the contact actuation sensor operating section 72 that is disposed close to the contact actuation sensor 71. When the contact actuation sensor 71 senses contact, the output signal of the contact actuation sensor 71 changes, and this change is detected by the control unit 80 that is connected to the contact actuation sensor 71. Upon detection of the change in the signal inputted from the contact actuation sensor 71, the control unit 80 outputs a signal to the notification unit 90 that is connected to the control unit 80. In accordance with the output from the control unit 80, the notification unit 90 notifies the user that pressure inside the assembled battery case 30 has risen abnormally. In the battery system 200, there is sensed the deformation of the deformation section 50 provided in the assembled battery case 30, instead of performing direct monitoring of the pressure inside the assembled battery case 30. Therefore, pressure anomalies inside the assembled battery case 30 can be sensed in a simple manner.

In the above explanation relating to the invention, the battery system 200 has been illustrated in a configuration wherein an assembled battery 15 of the battery system 200 has solid-state unit cells 10₁, . . . , 10_{N} that are lithium ion secondary batteries, but the invention is not limited to the above configuration. Each unit cell that makes up the assembled battery can be a unit cell other than a solid-state unit cell being a lithium ion secondary battery. For instance, a battery system may be configured so as to an have assembled battery that is made up of a plurality of unit cells being each a so-called gel electrolyte lithium secondary battery in which not only an electrolyte but also a solvent is held in a polymeric body.

In the explanation relating to the invention, the battery system 200 has been illustrated in a configuration wherein an assembled battery 15 of the battery system 200 has solid-state unit cells 10₁, . . . , 10_{N} connected in series, but the invention is not limited to the above configuration. A form is also possible in which the assembled battery is configured through parallel connection of solid-state unit cells. Alternatively, a configuration is also possible in which the assembled battery is constructed as a combination of series connection and parallel connection.

In the explanation relating to the invention, a configuration of the battery system 200 has been illustrated wherein the deformation section 50 is configured through partial lowering of rigidity, by shaping part of the outer plate that is to make up the assembled battery case 30 into a convex form, by pressing, but the invention is not limited to the above configuration. The deformation section in the battery system of the invention can be configured by causing rigidity to be lower than at the surroundings in accordance with a method other than the above-described pressing, for instance mutual joining, by welding or the like, of dissimilar materials. A configuration is also possible in which the rigidity of one face of the assembled battery case is lowered by making the plate thickness of the one face smaller than that of other faces. In that case, such one face constitutes the deformation section. That is, the entire one face deforms so as to bulge outwards from the assembled battery case as a result of an anomalous rise in the internal pressure of the assembled battery case. Another configuration is also possible in which the rigidity of the assembled battery case is not lowered partially; instead, all the faces that make up the assembled battery case have the same plate thickness, such that the entire assembled battery case constitutes a deformation section. That is, the entire assembled battery case deforms so as to bulge outwards as a result of an anomalous rise in the internal pressure of the assembled battery case.

In the explanation relating to the invention, a configuration of the battery system 200 has been illustrated wherein the latter has the contact actuation sensor 71 as a sensing section, but the invention is not limited to the above configuration. The battery system of the invention can be configured so that the sensing section has a sensor other than a contact actuation sensor. Examples of sensors, other than contact actuation sensors, that can make up the sensing section include, for instance, contact-less sensors such as beam sensors or the like.

In the explanation relating to the invention, a configuration of the battery system 200 has been illustrated wherein a signal is outputted by the contact actuation sensor 71 (sensing section) to the notification unit 90, via the control unit 80, but the invention is not limited to the above configuration. Depending on the form of the notification unit and of the sensor that makes up the sensing section, a configuration is also possible in which the notification unit operates upon direct signal transmission from the sensing section to the notification unit, without the intervening control unit. In a case where, for instance, the sensing section is made up of a switch sensor of a form such that a conduction state is elicited by contact, and the notification unit is made up of an LED that emits light when energized, then the LED (notification unit) can be caused to emit light when the sensor (sensing section) detects contact, also with the sensor (sensing section) and the LED (notification unit) being directly connected to each other without the intervening control unit.

In the explanation relating to the invention, a configuration of the battery system 200 has been illustrated wherein the power source necessary for the contact actuation sensor 71 (sensing section), the control unit 80 and the notification unit 90 is supplied from the assembled battery 15. The number of parts can be reduced in an easy manner in such a configuration of the battery system 200. However, the invention is not limited to these configurations in any way. A form is also possible in which the power source necessary for the sensing section, the control unit and the notification unit is supplied by a power source supply section other than the assembled battery in the battery system of the invention. Examples of such a power source supply section include, for instance, an air battery, a liquid battery, a solar cell or the like. Such a configuration allows sensing, for instance, anomalies in the internal pressure of the assembled battery case, in a manner unaffected by the state of charge of the assembled battery in the battery system.

In the explanation relating to the invention, a configuration of the battery system 200 has been illustrated wherein one assembled battery case 30 is provided inside one chassis 60, but the invention is not limited to the above configuration. A form is also possible in which a plurality of assembled battery cases is provided in one chassis. In an instance where a plurality of assembled battery cases is provided in one chassis, then each assembled battery case may have a deformation section, and there may be provided a plurality of sensing sections, in one chassis, that correspond to respective sensing sections.

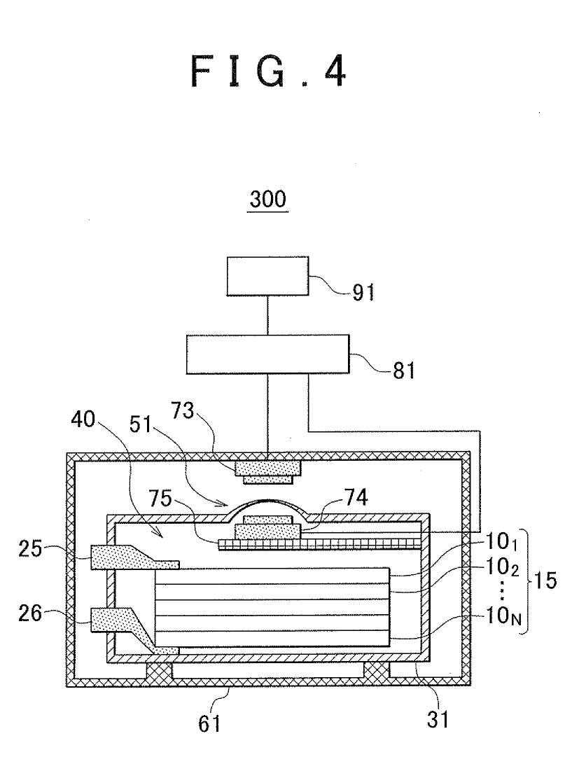

FIG. 4 is a cross-sectional diagram for explaining schematically a battery system 300 according to a third embodiment of the invention. As illustrated in FIG. 4, the battery system 300 is provided with an assembled battery 15; an assembled battery case 31 that houses the assembled battery 15; a gas 40 that fills the interior of the assembled battery case 31; a deformation section 51 provided in the assembled battery case 31; a chassis 61 that houses the assembled battery case 31; a first contact actuation sensor 73 disposed in the chassis 61; a second contact actuation sensor holding section 75 disposed on an inner face of the assembled battery case 31; a second contact actuation sensor 74 disposed by being held by the second contact actuation sensor holding section 75; a control unit 81 connected to the first contact actuation sensor 73 and the second contact actuation sensor 74; and a notification unit 91 connected to the control unit 81. The first contact actuation sensor 73 is disposed on an inner face of the chassis 61, close to the deformation section 51. The second contact actuation sensor 74 is held, inside the assembled battery case 31, by the second contact actuation sensor holding section 75, in such a way so as to be close to the deformation section 51. A positive electrode terminal 25 and a negative electrode terminal 26 are connected to the assembled battery 15. The positive electrode terminal 25 and the negative electrode terminal 26 are fixed to the assembled battery case 31, such that at least part of the positive electrode terminal 25 and the negative electrode terminal 26 is exposed outside the assembled battery case 31.

The assembled battery 15, being an assembled battery having the above-described configuration, is connected to the positive electrode terminal 25 and the negative electrode terminal 26.

The assembled battery case 31 is a member that houses the assembled battery 15 and that holds a gas 40 in such a manner that the latter does not leak out. Unlike the above-described assembled battery case 30, the assembled battery case 31 is an assembled battery case that takes on a predetermined shape by swelling when the interior thereof is pressure-filled with the gas 40. The assembled battery case 31 can be configured out of, for instance, a knockdown aluminum case having folding points. The assembled battery case 31 is provided with the below-described deformation section 51 and second contact actuation sensor holding section 75.

The gas 40 is a gas, having the above features, that is pressure-filled into the assembled battery case 31. The gas 40 has the function of maintaining a predetermined shape of the assembled battery case 31 while pressurizing the assembled battery 15 on account of hydrostatic pressure.

The deformation section 51 is a portion, provided on an outer plate of the assembled battery case 31, having partially reduced rigidity. That is, the deformation section 51 is a portion of the assembled battery case 31 having lower rigidity than other portions of the assembled battery case 31. In the battery system 300, the deformation section 51 as a protrusion can be formed, for instance, by pushing up a part, by pressing, of the outer plate that is to make up the assembled battery case 31, such that the pushed portion bulges upwards, prior to assembly of the assembled battery case 31. The plate thickness of the protrusion is made smaller than the surrounding plate thickness through stretching of the plate during pressing. As a result, the deformation section 51 has a lower rigidity than the surroundings.

As described above, the deformation section 51 has lower rigidity than the surroundings at the outer plate of the assembled battery case 31. As a result, the deformation section 51 deforms so as to bulge outwards from the assembled battery case 31, ahead of other portions of the assembled battery case 31 (hereafter also referred to as “expansion deformation”), when the internal pressure in the assembled battery case 31 rises abnormally, and the difference with the external pressure of the assembled battery case 31 exceeds a predetermined threshold value. Herein, the difference between the external pressure and the internal pressure of the assembled battery case 31 (internal-external pressure difference) that constitutes a threshold value of the time at which deformation of the deformation section 51 starts is preferably set to be 10% or more of the external pressure. Preferably, thus, the deformation section 51 expands and deforms when the internal pressure rises to be 10% or more higher than the external pressure. Expansion and deformation of the deformation section 51, triggered when the internal pressure exceeds the external pressure by 10% or more, allows easing malfunctions upon fluctuations in the internal-external pressure difference that derive from external factors, such as temperature or the like.

When the difference between the internal pressure and the external pressure of the assembled battery case 31 (internal pressure-external pressure) drops below a predetermined threshold value as a result of an abnormal drop of internal pressure in the assembled battery case 31, the deformation section 51 deforms, so as to bulge inward from the assembled battery case 31, ahead of other portions of the assembled battery case 31 (this is also referred to hereafter as “contraction deformation”). Herein, the difference between the internal pressure and the external pressure of the assembled battery case 31 (internal-external pressure difference) that constitutes a threshold value of the time at which contraction deformation of the deformation section 51 starts is preferably set to be 10% or more of the external pressure. Preferably, the deformation section 51 contracts and deforms thus when the internal pressure drops below the external pressure by 10% or more. Contraction and deformation of the deformation section 51, triggered when the internal pressure drops below the external pressure by 10% or more, allows easing malfunctions upon fluctuations in the internal-external pressure difference that derive from external factors, such as temperature or the like.

The chassis 61 is a member that houses the assembled battery case 31 and holds the latter at an appropriate position, and that holds the first contact actuation sensor 73 at an appropriate position. A chassis having the same configuration as that of the above-described chassis 60 can be used as the chassis 61.

The first contact actuation sensor 73 is a sensor, disposed inside the chassis 61, that senses expansion deformation of the deformation section 51. The first contact actuation sensor 73 is connected to the below-described control unit 81, such that the output of the first contact actuation sensor 73 is transmitted to the control unit 81. In a case where a power source is necessary to operate the first contact actuation sensor 73, power is supplied to the first contact actuation sensor 73 by way of a power source wire, not shown, through the positive electrode terminal 25 and the negative electrode terminal 26 to which the assembled battery 15 is connected. The first contact actuation sensor 73 is disposed on an inner face of the chassis 61, close to the deformation section 51. That is, the first contact actuation sensor 73 is disposed at a position that comes into contact with a portion of the deformation section 51 that is provided in the above-described assembled battery case 31, when the deformation section 51 deforms so as to bulge outwards (expansion deformation). A sensor having a configuration identical to that of the above-described contact actuation sensor 70 can be used as the first contact actuation sensor 73. Preferably, a predetermined gap in normal times is provided between the first contact actuation sensor 73 and the deformation section 51. The size of the gap can be set to be similar to that of the gap between the contact actuation sensor 70 and the deformation section 50 in the above-described battery system 100.

The second contact actuation sensor 74 is a sensor, disposed inside the assembled battery case 31 and held by the below-described second contact actuation sensor holding section 75, that senses contraction deformation of the deformation section 51. The first contact actuation sensor 73 and the second contact actuation sensor 74 make up the sensing section in the battery system 300. The second contact actuation sensor 74 is connected to the below-described control unit 81, such that the output of the second contact actuation sensor 74 is transmitted to the control unit 81. In a case where a power source is necessary to operate the second contact actuation sensor 74, power is supplied to second contact actuation sensor 74 by way of a power source wire, not shown, through the positive electrode terminal 25 and the negative electrode terminal 26 to which the assembled battery 15 is connected. The second contact actuation sensor 74 is disposed inside the assembled battery case 31, close to the deformation section 51. That is, the second contact actuation sensor 74 is disposed at a position, inside the assembled battery case 31, that comes into contact with a portion of the deformation section 51 that is provided in the above-described assembled battery case 31, when the deformation section 51 deforms so as to bulge inwards (contraction deformation). A sensor having a configuration identical to that of the above-described contact actuation sensor 70 can be used as the second contact actuation sensor 74. Preferably, a predetermined gap in normal times is provided between the second contact actuation sensor 74 and the deformation section 51. The size of the gap can be set to be similar to that of the gap between the contact actuation sensor 70 and the deformation section 50 in the above-described battery system 100.

The second contact actuation sensor holding section 75 is a member disposed on an inner face of the assembled battery case 31 and that holds the second contact actuation sensor 74 at a predetermined position. The second contact actuation sensor holding section 75 need only be capable of holding the second contact actuation sensor 74 in such a manner that the second contact actuation sensor 74 operates reliably upon contact between the contraction-deformed deformation section 51 and the second contact actuation sensor 74. Such a second contact actuation sensor holding section 75 can be made up of, for instance, a metal plate or the like.

The control unit 81 controls the first contact actuation sensor 73, the second contact actuation sensor 74 and the below-described notification unit 91. To that end, the control unit 81 is connected to all of the first contact actuation sensor 73, the second contact actuation sensor 74 and the notification unit 91. Specifically, the control unit 81 receives, and processes, an output signal from the first contact actuation sensor 73 and the second contact actuation sensor 74, and, when the output signal indicates detection of deformation of the deformation section 51, this indication is outputted to the below-described notification unit 91. The content of the output from the control unit 81 to the notification unit 91 may be identical for the operation of either of the first contact actuation sensor 73 and the second contact actuation sensor 74, or may be dissimilar between an instance where the first contact actuation sensor 73 detects contact and an instance where the second contact actuation sensor 74 detects contact. In a case where a power source is required for the operation of the control unit 81, power is supplied to the control unit 81 by way of a power source wire, not shown, through the positive electrode terminal 25 and the negative electrode terminal 26 to which the assembled battery 15 is connected. An available control device such as a microcontroller or the like may be used, without any particular limitations, as the control unit 81.

The notification unit 91 is connected to the control unit 81, and, in accordance with the output of the control unit 81, informs a user that an anomaly in the assembled battery case 31 has been detected. In a case where a power source is required for the operation of the notification unit 91, power is supplied to the notification unit 91 by way of a power source wire, not shown, through the positive electrode terminal 25 and the negative electrode terminal 26 to which the assembled battery 15 is connected. As the notification unit 91 there can be used a light-emitting element such as a light bulb, an LED, an organic EL or the like; a text display element such as a liquid crystal module or a liquid crystal panel; an acoustic element such as a piezoelectric buzzer; or a transducer or the like; singly or as a combination of a plurality thereof. The output signal from the control unit 81 may be sent to an on-board information system such as a car navigation system, so that notification is performed by the latter. In that case, the on-board information system functions as the notification unit 91. In a case where the above-described control unit 81 outputs a content that is different between an instance where the first contact actuation sensor 73 detects contact and an instance where the second contact actuation sensor 74 detects contact, the notification unit 91 may notify two types of anomaly along with the abovementioned outputs of dissimilar content. Examples of such a notification unit 91 include, for instance, a display device resulting from combining a plurality of LEDs.

Conceivable situations that may result in expansion deformation of the deformation section 51 in the battery system 300, i.e. conceivable causes of abnormal rises in pressure inside the assembled battery case 31 include, for instance, overheating arising from use under harsh high-temperature environments; rises in the pressure of the gas 40 itself, as a result of anomalous heat generation caused by excessive current flow on account of a failure such as a short-circuit or the like; and also rises in the internal pressure of the airtight assembled battery case 31 through generation of gas as a result of anomalous reactions inside the assembled battery 15. An explanation follows next on the operation of the battery system 300 in a case of anomalous rise of the pressure inside the assembled battery case 31.

When the pressure inside the assembled battery case 31 rises for some reason and the internal-external pressure difference exceeds the predetermined expansion deformation threshold value, the deformation section 51 provided in the assembled battery case 31 deforms, so as to bulge outwards, ahead of other portions of the assembled battery case 31 (expansion deformation). Upon deformation of the deformation section 51, the deformation section 51 comes into contact with the first contact actuation sensor 73 that is provided in the chassis 61, close to the deformation section 51 before deformation. When the first contact actuation sensor 73 senses contact, the output signal of the first contact actuation sensor 73 changes, and this change is detected by the control unit 81 that is connected to the first contact actuation sensor 73. Upon detection of the change in the signal inputted from the first contact actuation sensor 73, the control unit 81 outputs a signal to the notification unit 91 that is connected to the control unit 81. In accordance with the output from the control unit 81, the notification unit 91 notifies the user that an anomaly relating to pressure inside the assembled battery case 31 has occurred, or that pressure inside the assembled battery case 31 has risen abnormally. In the battery system 300, there is sensed the deformation of the deformation section 51, instead of performing direct monitoring of the pressure inside the assembled battery case 31. Therefore a pressure anomaly or anomalous rise in pressure in the assembled battery case 31 can be can be sensed in a simple manner.

Conceivable situations that may result in contraction deformation of the deformation section 51 in the battery system 300, i.e. conceivable causes of abnormal drops in pressure inside the assembled battery case 31 include, for instance, drops in the pressure itself of the gas 40 as a result of under-cooling during use in a harsh low-temperature environment, or drops in the internal pressure in the assembled battery case 31 as a result of leaks of gas 40, to the exterior of the assembled battery case 31, when the airtightness of the assembled battery case 31 breaks down for some cause. An explanation follows next on the operation of the battery system 300 in a case where the pressure inside the assembled battery case 31 drops abnormally.

When the pressure inside the assembled battery case 31 drops for some reason and the internal-external pressure difference drops below the predetermined contraction deformation threshold value, the deformation section 51 provided in the assembled battery case 31 deforms, so as to bulge inward, ahead of other portions of the assembled battery case 31 (contraction deformation). Upon contraction deformation of the deformation section 51, the deformation section 51 comes into contact with the second contact actuation sensor 74 that is disposed inside the assembled battery case 31, close to the deformation section 51 before deformation. When the second contact actuation sensor 74 senses contact, the output signal of the second contact actuation sensor 74 changes, and this change is detected by the control unit 81 that is connected to the second contact actuation sensor 74. Upon detection of the change in the signal inputted from the second contact actuation sensor 74, the control unit 81 outputs a signal to the notification unit 91 that is connected to the control unit 81. In accordance with the output from the control unit 81, the notification unit 91 notifies the user that an anomaly relating to pressure inside the assembled battery case 31 has occurred, or that pressure inside the assembled battery case 31 has dropped abnormally. In the battery system 300, there is sensed the contraction deformation of the deformation section 51, instead of performing direct monitoring of the pressure inside the assembled battery case 31. Therefore a pressure anomaly or anomalous drop in pressure in the assembled battery case 31 can be can be sensed in a simple manner.

As described above, the battery system 300 has the first contact actuation sensor 73 and the second contact actuation sensor 74 that are disposed outside and inside the assembled battery case 31, respectively. In the battery system 300, as a result, anomalous rises and drops in temperature inside the assembled battery case 31 can both be sensed in a simple manner. Therefore, situations of possible loss of performance of the assembled battery 15 in the battery system 300, or situations of possible threats to the safety of the battery system 300 itself, can be sensed in a simple manner.

In the above explanation relating to the invention, the battery system 300 has been illustrated in a configuration wherein an assembled battery 15 of the battery system 300 has solid-state unit cells 10₁, . . . , 10_{N} that are lithium ion secondary batteries, but the invention is not limited to the above configuration. Each unit cell that makes up the assembled battery can be a unit cell other than a solid-state unit cell being a lithium ion secondary battery. For instance, a battery system may be configured so as to an have assembled battery that is made up of a plurality of unit cells being each a so-called gel electrolyte lithium secondary battery in which not only an electrolyte but also a solvent is held in a polymeric body.

In the explanation relating to the invention, the battery system 300 has been illustrated in a configuration wherein an assembled battery 15 of the battery system 300 has solid-state unit cells 10₁, . . . , 10_{N} connected in series, but the invention is not limited to the above configuration. A form is also possible in which the assembled battery is configured through parallel connection of solid-state unit cells, Alternatively, a configuration is also possible in which the assembled battery is constructed as a combination of series connection and parallel connection.

In the explanation relating to the invention, a configuration of the battery system 300 has been illustrated wherein the deformation section 51 is configured through partial lowering of rigidity, by shaping part of the outer plate that is to make up the assembled battery case 31 into a convex form, by pressing, but the invention is not limited to the above configuration. The deformation section in the battery system of the invention can be configured by causing rigidity to be lower than at the surroundings in accordance with a method other than the above-described pressing, for instance mutual joining, by welding or the like, of dissimilar materials. A configuration is also possible in which the rigidity of one face of the assembled battery case is lowered by making the plate thickness of the one face smaller than that of other faces. In that case, such one face constitutes the deformation section. That is, the entirety of the above-mentioned one face deforms so as to bulge outward from the assembled battery case (expansion deformation) when the internal pressure in the assembled battery case rises abnormally. Also, entirety of the abovementioned one face deforms so as to bulge inward from the assembled battery case (contraction deformation) when the internal pressure in the assembled battery case drops abnormally. Another configuration is also possible in which the rigidity of the assembled battery case is not lowered partially; instead, all the faces that make up the assembled battery case have the same plate thickness, such that the entire assembled battery case constitutes a deformation section. That is, the entire assembled battery case deforms so as to bulge outward (expansion deformation) when the internal pressure in the assembled battery case rises abnormally, and the entire assembled battery case deforms so as to bulge inwards (contraction deformation) when the internal pressure in the assembled battery case drops abnormally.

In the explanation relating to the invention, a configuration of the battery system 300 has been illustrated wherein the latter has the first contact actuation sensor 73 and the second contact actuation sensor 74 as the sensing section, but the invention is not limited to the above configuration. The battery system of the invention can be configured so that the sensing section has a sensor other than a contact actuation sensor. Examples of sensors, other than contact actuation sensors, that can make up the sensing section include, for instance, contact-less sensors such as beam sensors or the like.

In the explanation relating to the invention, the battery system 300 has been illustrated in a configuration wherein the first contact actuation sensor 73 that makes up the sensing section is disposed on an inner face of the chassis 61, but the invention is not limited to the above configuration. In an electronic system of the invention, the sensing section need only be disposed so as to be capable of sensing the deformation of the deformation section. Therefore, a configuration is possible wherein the first contact actuation sensor is held, by way of a positioning section such a spacer or the like that is disposed on an inner face of the chassis, in accordance with a desired positional relationship between the first contact actuation sensor and the deformation section.

In the explanation relating to the invention, the battery system 300 has been illustrated in a configuration wherein the first contact actuation sensor 73 and the second contact actuation sensor 74 (sensing section) output a signal to the notification unit 91 via the control unit 81, but the invention is not limited to the above configuration. Depending on the form of the notification unit and of the sensor that makes up the sensing section, a configuration is also possible in which the notification unit operates upon direct signal transmission from the sensing section to the notification unit, without the intervening control unit. In a case where, for instance, both the first contact actuation sensor and the second contact actuation sensor that constitute the sensing section are made up of switch sensors of a form such that a conduction state is elicited by contact, and the notification unit is made up of two LEDs that emit light when energized, then one of the LEDs and the first contact actuation sensor may be directly connected, without the intervening control unit, and the second contact actuation sensor and the other LED may be likewise directly connected, without the intervening control unit, so that, as a result, either LED (notification unit) can be caused to emit light, for notification to the user, when the sensor (sensing section) detects contact.

In the explanation relating to the invention, the battery system 300 has been illustrated in a configuration wherein the power source necessary for the first contact actuation sensor 73 and the second contact actuation sensor 74 (sensing section) as well as the control unit 81 and the notification unit 91 is supplied from the assembled battery 15. The number of parts can be reduced in an easy manner in such a configuration of the battery system 300. However, the invention is not limited to these configurations in any way. A form is also possible in which the power source necessary for the sensing section, the control unit and the notification unit is supplied by a power source supply section other than the assembled battery in the battery system of the invention. Examples of such a power source supply section include, for instance, an air battery, a liquid battery, a solar cell or the like. Such a configuration allows sensing, for instance, anomalies in the internal pressure of the assembled battery case, in a manner unaffected by the state of charge of the assembled battery in the battery system.

In the explanation relating to the invention, a configuration of the battery system 300 has been illustrated wherein one assembled battery case 31 is provided inside one chassis 61, but the invention is not limited to the above configuration. A form is also possible in which a plurality of assembled battery cases is provided in one chassis. In an instance where a plurality of assembled battery cases is provided in one chassis, then each assembled battery case may have a deformation section, and there may be provided a plurality of sensing sections, in one chassis, that correspond to respective sensing sections.

In the explanation relating to the invention, the battery system 300 has been illustrated in a configuration wherein the battery system 300 has a assembled battery case 31 that has a predetermined shape through pressure-filling of the gas 40 into the assembled battery case 31, but the invention is not limited to the above configuration. For instance, a configuration of the battery system is also possible in which the gas is pressure-filled not only into the interior of the assembled battery case, but also in the space inside the chassis but outside the assembled battery case. In a battery system having such a form, the deformation section can undergo contraction deformation as a result of a drop in pressure inside the assembled battery case, also for an assembled battery case the shape whereof is not maintained at a predetermined shape by virtue of internal pressure. In a battery system having such a form, therefore, it becomes possible to detect, in a simple manner, both anomalous rises and anomalous drops in pressure inside the assembled battery case, by providing a sensing section both outside and inside the assembled battery case.

In the explanation relating to the invention, the battery system 300 has been illustrated in a configuration wherein a sensing section (first contact actuation sensor 73 and second contact actuation sensor 74) is provided both inside and outside the assembled battery case 31, but the invention is not limited to the above configuration. A battery system is also possible wherein a sensing section is provided only inside the battery system. In this configuration, drops in the internal pressure of the assembled battery case can be sensed in a simple manner, and both the number of parts and costs can be reduced simultaneously.

A battery system according to a fourth embodiment of the invention has at least one laminate cell (unit cell) and an outer package (assembled battery case) that houses the at least one laminate cell, the battery system having a battery structure wherein the at least one laminate cell is pressurized and held through filling of a space inside the outer package with a gas, and wherein at least part of the outer surface of the outer package is covered by a material for detecting leaks of gas from the outer package.

FIG. 5 is a diagram illustrating schematically a laminate cell that is used ordinarily in a battery structure of the battery system of the fourth embodiment according of the invention. In the laminate cell 10, an electrode plate group 11 in which a separator sheet or the like is interposed, as the case may require, between a positive electrode sheet and a negative electrode sheet, is packaged by a laminate film 12 that is, for instance, a metal foil of aluminum or the like coated with a synthetic resin, to seal thereby the periphery of the electrode plate group 11 and yield a sealed plate-like airtight laminate cell 10. A positive electrode-side terminal electrode 13 and a negative electrode-side terminal electrode 14 that protrude outwards are provided at the ends of the laminate cell 10.

In the fourth embodiment, at least one laminate cell such as the above-described one is accommodated in the outer package. The outer package is not particularly limited, so long as it is sturdy and highly airtight, and as such there can be used, for instance, a metal or a resin material. The number of laminate cells that are accommodated within the outer package in the battery structure of the fourth embodiment is not particularly limited. The outer package can arbitrarily accommodate an appropriate number of laminate cells, depending on the capacity and output required by the application for which the battery structure is used.

Ordinarily, lowering the internal resistance of the laminate cell is crucial in order to enhance and/or preserve battery characteristics in a laminate cell such as the above-described one. Moreover, pressurizing the electrode plate group that makes up the laminate cell is found to be effective in lowering internal resistance, since pressurizing an electrode plate group that makes up a laminate cell allows reducing the contact resistance between materials, for instance active material particles, that are present in the electrode plate group. In any case, the effect elicited by such pressurization is particularly significant in battery structures that use laminate cells of high internal resistance.

The laminate cell in the battery structure according to the fourth embodiment is not particularly limited, but, preferably, a lithium ion battery is used, in particular an all-solid-state lithium ion battery that contains a solid electrolyte.

A nonaqueous electrolyte solution is ordinarily used in lithium ion batteries. Lithium salts dissolve in organic solvents, and hence the conductivity of an electrolyte solution in a lithium ion battery is very small compared to the conductivity of an aqueous electrolyte solution such as that of a nickel-cadmium secondary battery. Therefore, the internal resistance of lithium ion batteries is ordinarily greater than that of secondary batteries that use aqueous electrolyte solutions. All-solid state lithium ion batteries that employ a solid electrolyte are used as lithium ion batteries. In such all-solid-state lithium on batteries, however, contact resistance is especially large between solid materials, and, accordingly, the internal resistance of the battery is greater than that of a lithium ion battery that uses a nonaqueous electrolyte solution.

In the battery system according to the fourth embodiment of the invention, the battery structure is such that at least one laminate cell that is accommodated within the outer package is pressurized and held through filling of a gas into a space in the outer package. As a result, uniform pressure can be exerted, from all directions, onto the electrode plate group that makes up the laminate cell, and moreover, that pressure can be kept at a constant value. Therefore, this allows reducing contact resistance between materials in the electrode plate group, and suppressing fluctuations in the value of contact resistance. Such contact resistance lowering effect is particularly significant, and, accordingly, the internal resistance of the laminate cell can be reduced dramatically, in a case where, for instance, a lithium ion battery, in particular an all-solid-state lithium ion battery having a solid electrolyte, is used as the laminate cell having the battery structure of the fourth embodiment. Remarkable improvements in battery characteristics can be achieved as a result in a battery structure that is configured using such laminate cells. The gas that fills the interior of the outer package in the fourth embodiment is not particularly limited, and there can be used air or an inert gas such as nitrogen or argon. These gases can be filled to a pressure that ranges ordinarily from 9.8 kPa to 3.9×10³ kPa (0.1 kg/cm² to 40 kg/cm²).

In the fourth embodiment, at least part, and in particular the entirety, of the outer surface of the outer package is covered by a material for detecting leaks of gas from the outer package.

Ordinarily, leaks occur readily if a high-pressure gas fills the interior of the outer package. Also, the leaks are leaks of a gas, and hence the occurrence of the leak itself, as well as the portion at which the leak has occurred, can be determined less easily than in a case where a liquid or the like is used. In a battery structure wherein the outer package is not covered by such a material for detecting gas leaks, therefore, it may be impossible to determine easily that a drop in battery characteristic in the battery structure, resulting from a gas leak, has indeed been caused by a gas leak. For instance, gas leaks can be detected if a pressure gauge or the like is fitted to the battery structure, but the portion at which the leak occurs cannot be determined. This approach is not necessarily preferred, either, in terms of cost and the like.

In the battery structure of the battery system of the fourth embodiment, an outer surface portion, in particular, the entirety of the outer surface of the outer package, at which a gas leak is likely to occur, is covered by a material for detecting leaks of gas from the outer package; as a result, this allows easily determining the portion of the outer package at which a leak of gas from the outer package has occurred, if any, on account of, for instance, damage to the outer package. Therefore, the present battery structure allows taking quick and appropriate measures for restoring pressure inside the outer package in case of such an occurrence.

Also, covering the entirety of the outer surface of the outer package with a material for detecting gas leaks implies that, as a result, the entirety of at least one laminate cell that makes up the present battery structure is completely covered by a double structure, namely by the outer package and the abovementioned material. As a result, this configuration is advantageous in terms of increasing the degree of freedom in material selection for the outer package, as compared with a single outer package, or with an instance where only part of the outer surface of the outer package is covered by the abovementioned material.

As such a material for detecting gas leaks in the fourth embodiment there can be used any material that allows detecting gas leaks easily. The “material for detecting the leak of the gas” of the battery structure of the fourth embodiment is explained in detail below. These explanations are merely illustrative of an aspect of the fourth embodiment, and the features of the fourth embodiment are not meant to be limited to this specific aspect.

In a first aspect of the fourth embodiment, a material that allows detecting gas leaks on account of expansion of, or damage to, an airtight material is used as the material for detecting gas leaks. Such a material is not particularly limited, and may be an airtight film, for instance a film made up of a polymer or resin or a thin and fragile but airtight inorganic material case, for instance a case made up of a ceramic or the like. There may be used also an inorganic material, organic material or a composite of the foregoing materials, so long as the material has a function such as the abovementioned one.

These airtight materials are brought to close contact with the outer surface of the outer package, to cover thereby an outer surface portion of the outer package at which a gas leak occurs readily, for instance a gas injection port for filling the gas, to preferably cover thereby the entirety of the outer surface of the outer package, so that, as a result, the above airtight material expands or becomes damaged at a portion where a gas leak, if any, has occurred, and hence the abovementioned portion can be determined easily.

Alternatively, a precursor solution or the like of the airtight material is blown or coated onto part or the entirety of the outer surface of the outer package in accordance with, for instance, a sol-gel method, a coating method, an inkjet method or the like, followed by baking, curing or the like, to form thereby an airtight material at least at part of the outer surface of the outer package, such that the material allows detecting gas leaks on account of expansion of, or damage to, the airtight material.

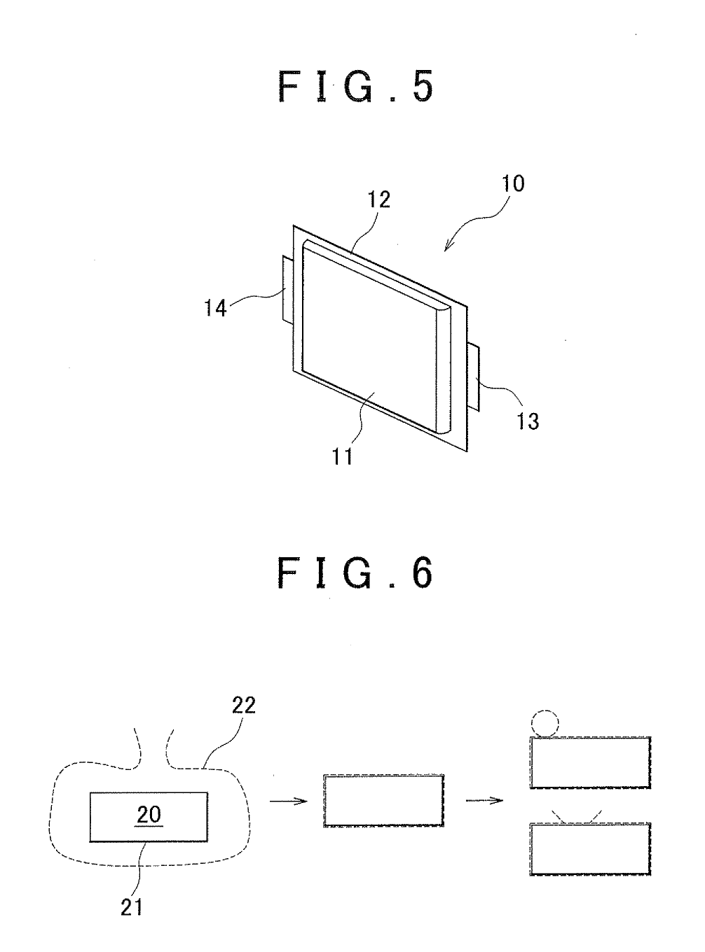

FIG. 6 is a diagram illustrating schematically an example of a battery structure in the fourth embodiment. Firstly, an outer package 21 of a battery structure 20 is enveloped in an airtight material 22 as illustrated in the left-side diagram of FIG. 6. Next, the entire outer surface of the outer package 21 is covered by the airtight material 22 in such a manner that the outer surface is completely in contact with the airtight material 22 (middle diagram in FIG. 6). In a case where the interior of the outer package 21 is filled with a high-pressure gas and no gas leak occurs, then the airtight material 22, in particular, does not deform or the like. If, however, the gas leaks from the interior of the outer package 21 on account of, for instance, damage to the outer package 21, then the airtight material 22 expands or becomes damaged, as illustrated in the right-side diagram of FIG. 6, at the portion at which such a gas leak has occurred. Therefore, that portion can be determined easily, which allows taking quick and appropriate measures for restoring pressure inside the outer package 21.

The material for detecting gas leaks that is used in a second aspect of the fourth embodiment is a material coated with microcapsules that have a pigment or dye sealed therein, such that the material allows detecting a gas leak through release of the pigment or dye upon rupture of the microcapsules. Using such a pressure-sensitive coloring material allows easily determining the portion at which a gas leak from the interior of the outer package has occurred, if any, on the basis of changes in the color of the pressure-sensitive coloring material.

In the present description, a battery structure has been explained in detail wherein a laminate cell is a lithium ion battery, but the battery structure in the fourth embodiment of the invention is not limited in any way to such specific battery structure, and may be used in any battery structure in which at least one laminate cell is accommodated within an outer package.

The battery system of the invention can be suitably used in a battery system that is provided in, for instance, an electric automobile or hybrid automobile.

What is claimed is:

1. A battery system, comprising:
an assembled battery having a plurality of solid-state unit cells;
an assembled battery case that houses the assembled battery;
a gas that fills an interior of the assembled battery case;
a pressing section that pressurizes the unit cells with hydrostatic pressure that is generated in the assembled battery case by the gas;
a deformation section that is part of the assembled battery case and that, upon occurrence of an anomaly in the assembled battery case, deforms in reaction to the anomaly; and
a sensing section that senses the deformation of the deformation section.

2. The battery system according to claim 1, wherein
the sensing section has a contact actuation sensor; and
the sensor is provided at a position such that the sensor operates when the deformation section deforms.

3. The battery system according to claim 1, wherein the deformation section is a portion of the assembled battery case, the portion having rigidity lowered with respect to that of other portions of the assembled battery case.

4. The battery system according to claim 1, wherein the anomaly to which the deformation section reacts is a situation where pressure inside the assembled battery case deviates from a predetermined range.

5. The battery system according to claim 2, wherein the sensor is provided at a position such that the sensor comes into contact with the deformation section when the deformation section deforms.

6. The battery system according to claim 2, wherein the sensor includes a first sensor section provided in the deformation section, and a second sensor section that comes into contact with the first sensor section when the deformation section deforms.

7. The battery system according to claim 2, wherein the sensor is disposed outside the assembled battery case.

8. The battery system according to claim 2, wherein the sensor is disposed inside the assembled battery case.

9. The battery system according to claim 1, wherein at least part of an outer surface of the assembled battery case is covered by a material for detecting a leak of the gas from the assembled battery case.

10. A battery structure, comprising:
at least one laminate cell; and
an outer package that houses the at least one laminate cell,
wherein:
the at least one laminate cell is pressurized and held through filling of a gas into a space in the outer package; and
at least part of an outer surface of the outer package is covered by a material for detecting a leak of the gas from the outer package.

11. The battery structure according to claim 10, wherein the laminate cell is an all-solid-state lithium ion battery that contains a solid electrolyte.

12. The battery structure according to claim 10, wherein an entire outer surface of the outer package is covered by the material for detecting the leak of the gas.

13. The battery structure according to claim 10, wherein:
the material for detecting the leak of the gas is an airtight material; and
the leak of the gas are detected through expansion of, or damage to, the airtight material.

14. The battery structure according to claim 10, wherein:
the material for detecting the leak of the gas is formed of a material coated with microcapsules that have a pigment or dye sealed therein; and
the leak of the gas are detected through release of the pigment or dye upon rupture of the microcapsules.
